(19) United States
(12) Patent Application Publication
(10) Pub. No.: US 2014/0338197 A1
(43) Pub. Date: Nov. 20, 2014

(54) KNIFE SHEATH

(71) Applicants: Spencer Frazer, Lynnwood, WA (US); David Shoemaker, Lynnwood, WA (US)

(72) Inventors: Spencer Frazer, Lynnwood, WA (US); David Shoemaker, Lynnwood, WA (US)

(21) Appl. No.: 14/214,755

(22) Filed: Mar. 15, 2014

Related U.S. Application Data
(60) Provisional application No. 61/800,431, filed on Mar. 15, 2013.

(51) Int. Cl. B26B 29/02

(52) U.S. Cl. CPC B26B 29/025
USPC 30/151

(57) ABSTRACT

A knife sheath is disclosed. In some embodiments, a knife sheath includes a knife opening to receive a knife having a light source, and an internal cavity to sheath a blade of the knife, and at least one light channel near the knife opening to align with the light source when the knife having a light source is sheathed in the knife opening, the at least one light channel configured to allow light from the light source to pass through the knife sheath while the knife is placed in the knife sheath.

### RELATED APPLICATIONS

This application claims the benefit of U.S. Provisional Application No. 61/800,431, filed Mar. 15, 2013.

### BACKGROUND

Knife sheaths are currently used to protect and secure knife blades. Recent developments in materials have allowed for rigid, lightweight and durable knife sheaths. These new materials do not always provide a secure fit for a knife in a sheath, but are cost effective and easy to mass produce. Additionally, recent developments in knife technologies have added functionality to knives that conventional knife sheaths are not designed for. For example, recently knives have been development with attached or integrated lighting. When a knife is secured in a sheath, the lighting may be obstructed.

### SUMMARY

Accordingly, various embodiments of knife sheaths are described below in the Detailed Description. This Summary is provided to introduce a selection of concepts in a simplified form that are further described below in the Detailed Description. This Summary is not intended to identify key features or essential features of the claimed subject matter, now or later presented, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a side plan view of an embodiment knife sheath showing a blade tensioner, a sheath lock and a light channel.

FIG. 2 is a section view of the knife sheath in FIG. 1 showing a blade tensioner, a sheath lock and a light channel.

FIG. 3 is a detailed section view of an embodiment blade tensioner as shown in FIG. 2.

FIG. 4 is a side plan view of an embodiment knife sheath showing a blade tensioner, a sheath lock and a light channel and a knife positioned within the sheath.

FIG. 5 is a section view of the knife sheath in FIG. 4 showing a blade tensioner, a sheath lock and a light channel and a knife positioned within the sheath.

FIG. 6 is a detailed section view of an embodiment blade tensioner as shown in FIG. 5.

FIG. 7 is a perspective view of the embodiment in FIG. 4 showing a light channel and a knife positioned within the sheath.

FIG. 8 is a perspective view of the embodiment in FIG. 4 showing a blade tensioner, a sheath lock and a knife positioned within the sheath.

FIG. 9 is a perspective view of an embodiment knife sheath showing a sheath lock and a light channel.

FIG. 10 is a detailed section view of the sheath lock in FIG. 9.

FIG. 11 is a side plan view of an embodiment knife sheath showing a lip fastener, a string cutter, a sharpener and a light channel.

FIG. 12 is a close up side plan view of an embodiment knife sheath showing a lip fastener, a sharpener and a light channel.

### DETAILED DESCRIPTION

A disclosed knife sheath accommodates a knife having one or more light sources integrated into a handle of the knife. The knife sheath includes or otherwise defines one or more light channels through which light shines from the one or more light sources while the knife is sheathed. The knife sheath enables a user to utilize the one or more light sources of the knife while the knife is sheathed without exposure of the knife blade. The knife sheath may include a clip that enables a user to easily and quickly remove the sheathed knife from a belt or other article, where the sheathed knife may be safely used as a handheld flashlight. In some embodiments the sheath may be made by multiple molded parts fixed together or may be a unitary part formed from a single mold.

A disclosed knife sheath includes one or more tensioners that apply pressure to a blade of a sheathed knife and/or to a handle of a sheathed knife. The one or more tensioners may reduce or preclude rattling of the knife while the knife is sheathed, and may serve to further secure the knife within the knife sheath. Each tensioner may each include or otherwise define a lever arm that protrudes from a surface of the knife sheath and that applies a spring force or pressure against the knife while the knife is sheathed. The one or more tensioners may provide a friction fit to any item that is being inserted into a hard or rigid material sheath. In some embodiments, magnets may be placed in the sheath to provide blade stabilization in place of, or in conjunction with tensioners.

A disclosed knife sheath includes a locking mechanism in the form of a sheath lock that retains a knife within a knife sheath. The sheath lock may take the form of a tab that is depressible by a user to release a knife from the knife sheath.

A disclosed knife sheath includes one or more drainage holes that permit liquids to drain from the knife sheath and to keep a blade of a sheathed knife dry.

The use of plastic, metal or other hard or rigid materials for sheaths has recently become popular. One of the major issues with these hard or rigid sheaths is that the sheathed knife or tool tends to rattle within the sheath. Some approaches to reducing rattle have focused on restraining the handle of the knife or tool. However, often it is the blade portion rather than the handle portion of a knife that rattles when sheathed. In one approach, a spring force is applied directly on the blade of the knife or other suitable body portion of a tool when sheathed. By applying a spring force directly to the part of the knife that rattles, such as the blade, a greater reduction or more effective reduction in rattling may be achieved.

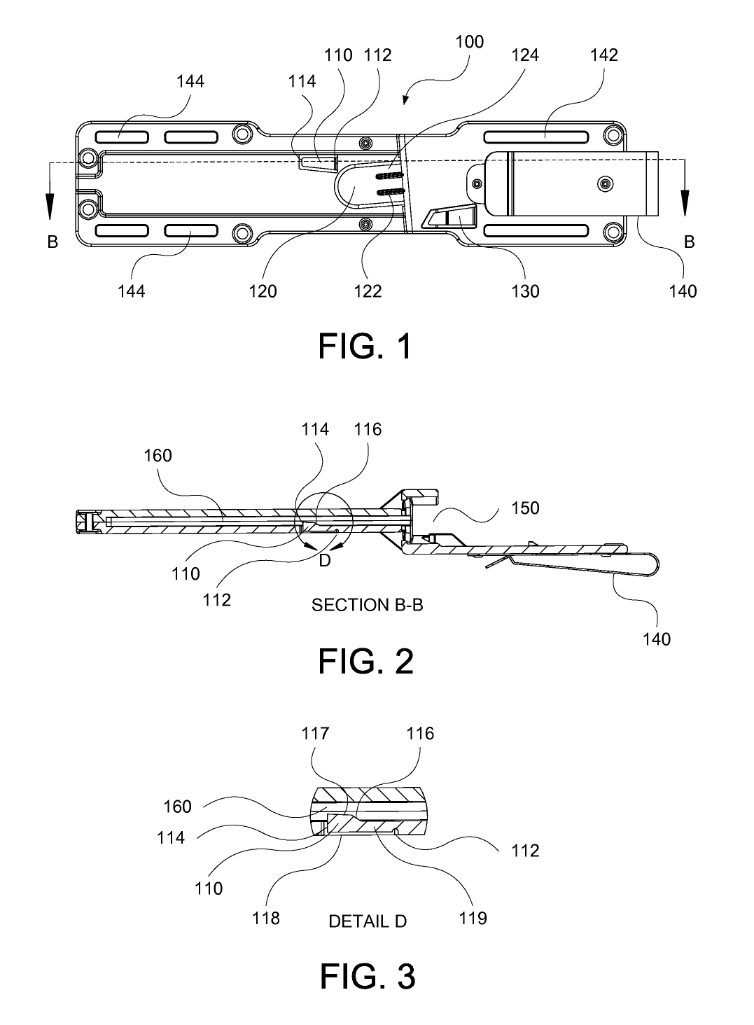

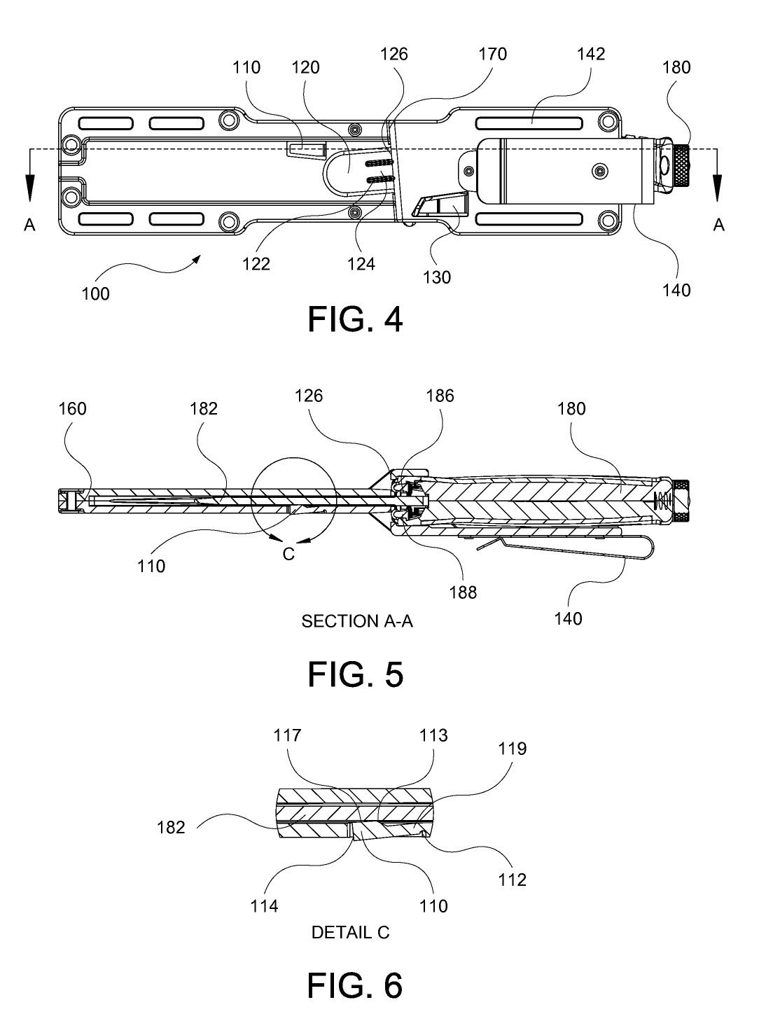

FIG. 1 is a side plan view of an embodiment knife sheath 100 showing a blade tensioner 110, a sheath lock 130 and a light channel 126. Knife sheath 100 accommodates a knife, as depicted in FIGS. 4-8, for example. It will be understood that knife sheath 100 may be configured for and/or paired for use with a particular knife. Hence, the features described herein with reference to knife sheath 100 may have different forms if used to sheath knives having different forms or other suitable tools.

Blade tensioner 110 includes or otherwise defines a lever arm 114 that pivots about a pivot joint 112 to apply a spring force and/or pressure against a knife blade of a knife while sheathed within knife sheath 100. Blade tensioner 110 is depicted in further detail by FIG. 3.

Knife sheath 100 includes or otherwise defines a light channel 126 that permits light to shine from a light source located at a handle of a sheathed knife through the knife sheath along a light path. Light channel 126 may be one of a plurality of light channels of knife sheath 100. For example, knife sheath 100 includes or otherwise defines a set of three light channels (including example light channel 126) on a first side of the knife sheath. Knife sheath 100 further includes another set of three light channels on a second side of the knife sheath for a total of six light channels, as depicted in FIG. 2, for example. A knife sheath may include any suitable number of light channels that correspond to any suitable number of light sources of a knife.

Knife sheath 100 may include or otherwise define a variety of surfaces that directs light along a light path. In addition to interior surfaces of the light channels, knife sheath 100 may include or otherwise define a recessed region 120 having a surface 124 that directs light along the light path. Knife sheath 100 may include or otherwise define one or more channel guides located between the light channels that include surfaces that direct light along the light path. Example channel guide 122 is located between two light channels. The channel guides, including channel guide 122, may also serve as structural supports of knife sheath 100.

The surfaces of knife sheath 100 formed by the light channels, recessed region 120, and channel guides collectively direct light along a light path that is angled relative to a knife insertion and removal axis of the knife sheath 100 as viewed within the plane of FIG. 1. In another embodiment, the surfaces of knife sheath 100 may direct light along a light path that is parallel to or substantially parallel to the knife insertion and removal axis of knife sheath 100 as viewed within the plane of FIG. 1.

Each light channel depicted in FIG. 1, including light channel 126, is fully enclosed by one or more interior surfaces of knife sheath 100 along an axis of the light path. In another embodiment, one or more light channels may be partially open along the axis of the light path. In some examples, the light channels may include a light transmitting or light permeable film or element that spans a cross section of the light channels. For example, a light channel may include a transparent or translucent plastic window.

Knife sheath 100 includes a clip 140 that may be used to secure knife sheath 100, including a knife sheathed therein, to a belt or other suitable article. Clip 140 enables a user to easily and quickly remove the sheathed knife from a belt or other article, where the sheathed knife may be safely used as a handheld flashlight. Knife sheath 100 includes or defines one or more other channels 142, 144, etc. that may be used to secure knife sheath 100 to an article.

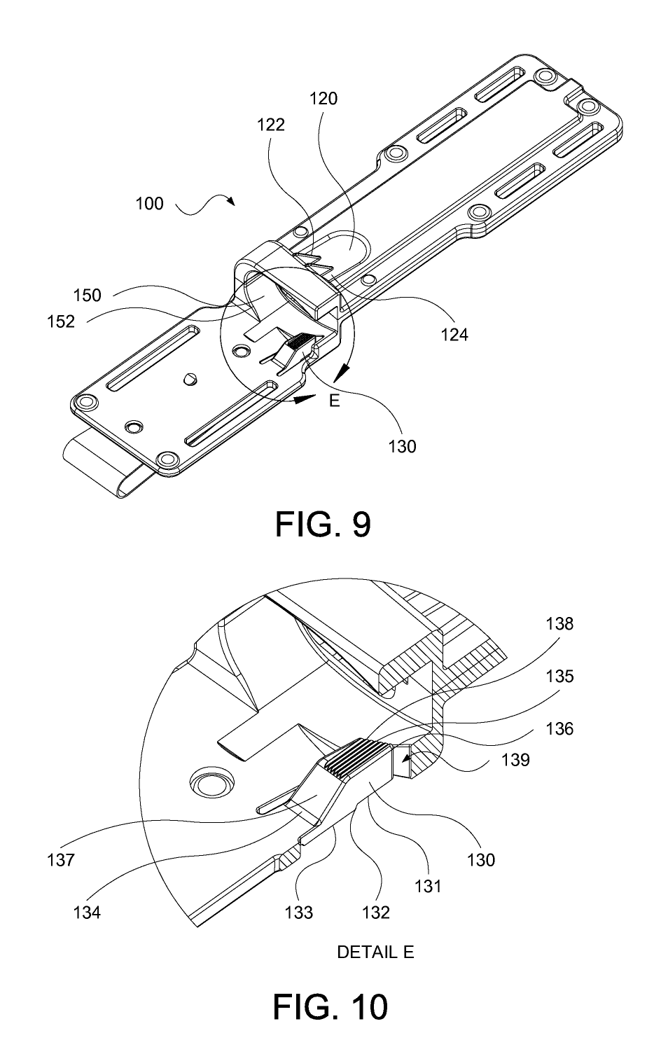

Knife sheath 100 includes a sheath lock 130 that engages with and retains a handle of a knife while the knife is sheathed. Sheath lock 130 is depicted in further detail by FIGS. 9 and 10.

FIG. 2 is a section view of the knife sheath 100 in FIG. 1 showing a blade tensioner 110, a sheath lock 130 and a light channel 126. Knife sheath 100 includes or otherwise defines a blade region 160 that accommodates a blade of a knife. A blade of a knife may be inserted into blade region 160 via an entry region 150. Clip 140 is depicted in further detail in FIG. 2.

Light channel 126 and channel guide 122 are depicted in further detail in FIG. 2. As previously described, knife sheath 100 may include additional light channels located on another side of knife sheath 100 from light channel 126. FIG. 2 depicts an example light channel 128 located on an opposite side of knife sheath 100 from light channel 126. Light channel 128 may be one of a plurality of light channels. For example, light channel 128 may be one of three light channels forming a set of light channels. FIG. 2 further depicts a channel guide 129 associated with light channel 128. Channel guide 129 may be one of two channel guides that are located between the three light channels of the set containing light channel 128.

Blade tensioner 110 is also depicted in further detail with lever arm 114 and pivot joint 112. Lever arm 114 includes a surface 116 that provides a transition between a protruding distal end of lever arm 114 and an intermediate portion of lever arm 114 between the distal end and pivot joint 112. Blade tensioner 110 is depicted in further detail by FIG. 3.

FIG. 3 is a detailed section view of an embodiment blade tensioner 110 as shown in FIG. 2. As previously described, blade tensioner 110 includes or otherwise defines a lever arm 114 that pivots about a pivot joint 112. Lever arm 114 in combination with pivot joint 112 takes the form of a “living spring” element that applies a spring force and/or pressure against a knife blade of a knife while sheathed within knife sheath 100.

Pivot joint 112 may be defined or formed by a narrowed region or other suitable reduction of material at an interface between lever arm 114 and the remaining body of knife sheath 100. Lever arm 114 may include an intermediate portion 119 having an interior surface facing blade region 160 that is substantially coplanar with other internal surfaces of the remaining body of knife sheath 100. Lever arm 114 may further include or otherwise define raised surfaces 116 and 117 that protrude or project into blade region 160, at least while a knife blade is not inserted into knife sheath 100. Surface 116 provides a transition between an interior surface of intermediate portion 119 and surface 117. Surface 117 interfaces with a knife blade that is inserted into knife sheath 100 causing lever arm 114 to pivot away from blade region 160 about pivot joint 112. Blade tensioner 110 may be recessed relative to an outer surface 118 of knife sheath 110 while a knife blade is not inserted into knife sheath 100. Blade tensioner 110 may be recessed to provide space for lever arm 114 to pivot away from blade region 160 while a knife blade is inserted into knife sheath 100 without protruding or projecting from outer surface 118 or so that lever arm 114 protrudes or projects from outer surface 118 to a lesser extent.

FIG. 4 is a side plan view of an embodiment knife sheath 100 showing a blade tensioner 110, a sheath lock 130 and a light channel 126 and a knife 180 positioned within the sheath.

FIG. 5 is a section view of the knife sheath 100 in FIG. 4 showing a blade tensioner 110, a sheath lock 130 and a light channel 126 and a knife 180 positioned within the sheath. In FIG. 5, a blade 182 of knife 180 resides within blade region 160. Blade tensioner 110 is depicted in FIG. 5 displaced by blade 182 such that the lever arm of blade tensioner 110 has pivoted relative to the position depicted in FIGS. 2 and 3.

In FIG. 5, light channel 126 is aligned or substantially aligned with a light source 186 of knife 180. A light channel may also align or substantially aligned with a light source 188 of knife 180. Light sources 186 and 188 may take the form of a light emitting diode (LED), for example. Each light channel of knife sheath 100 may correspond with a respective light source of knife 180. For example, if knife 180 includes six light sources, then knife sheath 100 may include six corresponding light channels. However, in another embodiment, two or more light sources may share a common light channel.

FIG. 6 is a detailed section view of an embodiment blade tensioner 110 as shown in FIG. 5. In FIG. 6, blade 182 of knife 180 residing within the blade region of the knife sheath contacts surface 117 of lever arm 114 at point 113. Blade tensioner 110 has been displaced by blade 182 such that lever arm 114 has pivoted about pivot joint 112 relative to the position depicted in FIGS. 2 and 3. Displacement of blade tensioner 110 and/or pivoting of lever arm 114 may cause material deformation of the blade tensioner at or near pivot joint 112, as indicated at point 119, for example.

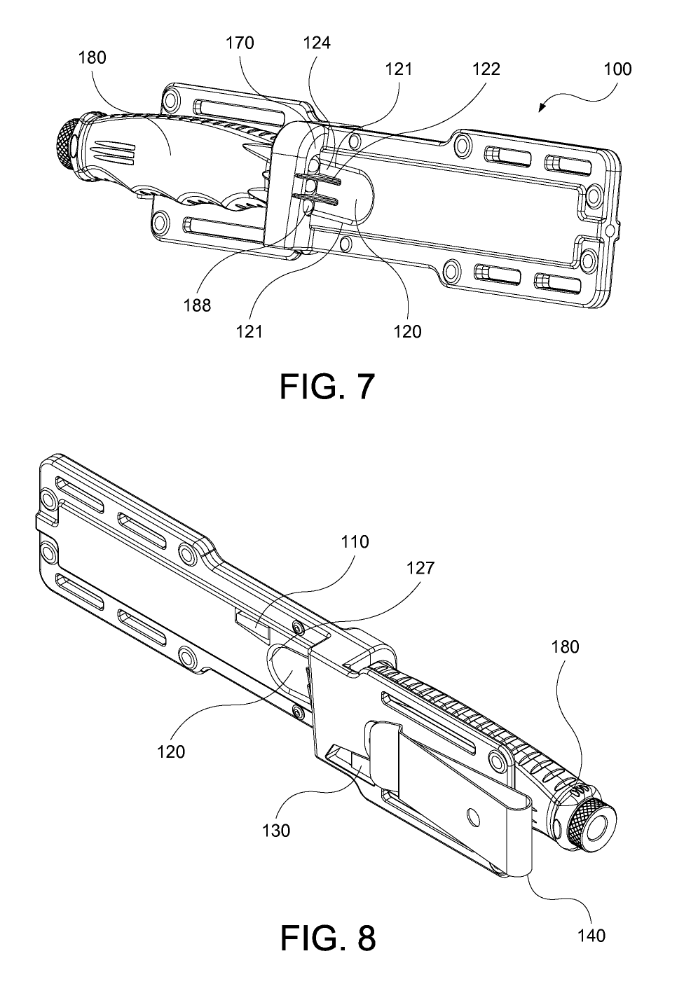

FIG. 7 is a perspective view of the embodiment in FIG. 4 showing a light channel and a knife 180 positioned within the sheath. FIG. 7 depicts one or more light channels formed within sheath portion 170 of knife sheath 100. Light source 188 of knife 180 is visible through a light channel. Sheath portion 170 accommodates at least a portion of an upper handle portion of knife 180. FIG. 7 depicts surface 124 of recessed region 120 and in further detail. Recessed region 120 joins other surfaces of knife sheath 100 by a transition surface 121 that may further direct light originating from the light sources along a light path. FIG. 7 further depicts how the various surfaces of the knife sheath may be angled relative to an insertion and removal axis of the knife to provide an angled light path. It will be understood that these surfaces may also serve to angle the light path in other coordinate directions, such as outward in a direction that is orthogonal to surface 124 of knife sheath 100.

FIG. 8 is a perspective view of the embodiment in FIG. 4 showing a blade tensioner 110, a sheath lock 130 and a knife 180 positioned within the sheath. FIG. 8 depicts another recessed region 120 located on an opposite side of knife sheath 100 from the recessed region of FIG. 7. FIG. 8 depicts transition surface 127 that joins surfaces of recessed region 120 of FIG. 8 to other surfaces of the knife sheath, and may further direct light originating from light sources of the knife along a light path. FIG. 8 depicts clip 140 in further detail.

FIG. 9 is a perspective view of an embodiment knife sheath 100 showing a sheath lock 130 and a light channel. FIG. 9 depicts recessed region 120, surface 124, and channel guide 122 in further detail. Entry region 150 of previously described sheath portion 170 is at least partially defined by interior surface 150. Interior surface 150 interfaces with an upper handle portion of a knife, and may have a form that accommodates and corresponds to the form of the upper handle portion. In FIG. 9, interior surface 150 only partially surrounds the upper handle portion while leaving an opening near sheath lock 130. This opening may provide access to sheath lock 130.

Knife sheath 100 may include or otherwise define a sheath drain 185 that enables liquid to flow outward from the interior of the knife sheath (e.g., the blade region), and may serve to keep the knife blade dry.

Knife sheath 100 may include an additional retaining element 175 that projects from a surface of the knife sheath. Retaining element 175 interfaces with and corresponds to a recessed feature in a surface of the knife handle. Retaining element 175 may further serve to lock or retain the knife within the knife sheath in conjunction with sheath lock 130. Retaining element 175 may take the form of a fixed protrusion or may take the form of a handle tensioner that applies a spring force or pressure to the knife handle. It will be understood that retaining element 175 when taking the form of a pivoting handle tensioner may, for example, utilize a pivoting lever arm, such as described with reference to blade tensioner 110.

FIG. 10 is a detailed section view of the sheath lock 130 in FIG. 9. Sheath lock 130 projects from or protrude relative to other surfaces of the knife sheath. Sheath lock 130 may include transition surfaces 134 and 137 between the other surfaces of the knife sheath and an upper surface 138 of sheath lock 130. Transition surfaces 134 and 137 facilitate sheathing by permitting portions of a knife to pass over sheath lock 130 during a sheathing operation of the knife. Upper surface 138 may include surface text in the form of ridges, grain, or other suitable structure that enables a user to gain purchase on surface 130 and depress surface 130 to release the knife from the knife sheath.

While sheathed, surfaces 135 and/or 136 may interface with and/or correspond to handle portions of the knife, such as a finger guard, for example. A gap 139 at least partially surrounding sheath lock 130 on one, two or more sides, permits sheath lock 130 to pivot downward about a pivot joint 132 responsive to pressure applied to upper surface 138. As one example, sheath lock 130 may take the form of a depressible tab. Pivot joint 132 may reside at a transition point between surface 133 and surface 131 of the knife sheath, and may enable sheath lock 130 to pivot as a result of material deformation at or near pivot joint 132.

While a single blade tensioner is depicted, it will be understood that another embodiment may include two, three, four, or more blade tensioners located on individual or opposing sides of a knife blade. Furthermore, while a single retaining element 175 is depicted, it will be understood that another embodiment, may include two, three, four, or more retaining elements for handle portions of a knife. Further still, while a single sheath lock 130 is depicted, it will be understood that another embodiment may include two, three, four or more sheath locks. Any suitable number of blade tensioners, handle retaining elements, and/or sheath locks may be used in combination to secure a knife within a knife sheath. For example, a plurality of blade tensioners, handle retaining elements, and/or sheath locks may be used to restrain all 6 degrees of freedom of a sheathed knife or other suitable tool.

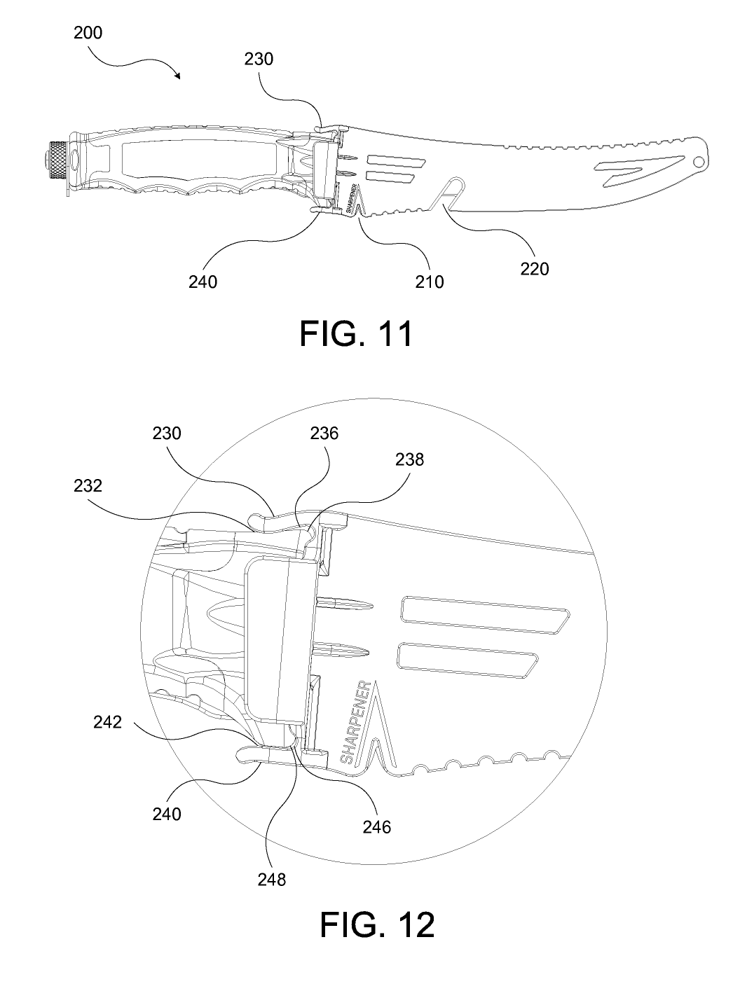

FIG. 11 is a side plan view of an embodiment knife sheath showing a lip fastener 230, a string cutter 220, a sharpener 210 and a light channel as depicted in other embodiments herein. In this embodiment, the sheath lip fastener 230 can receive a knife by having portions that flex around the knife handle when the knife is inserted and then relax to a position obstructing removal of the knife handle. Additionally, in this embodiment a string cutter 220 is shown that has an opening in the knife sheath that exposes a cutting blade of the knife through the opening. This allows a string, line, rope, wire, fabric, etc., to be placed within the string cutter 220 to be cut on the blade while the blade is not exposed outside the string cutter 220 so the knife can safely be grabbed, stowed or manipulated while in the sheath. In some embodiments, sheath may also have a knife sharpener 210 as illustrated in FIGS. 11 and 12.

FIG. 12 is a close up side plan view of an embodiment knife sheath showing a lip fastener 230, a sharpener 210 and a light channel. FIG. 12 illustrates a close up side pan view of the embodiment in FIG. 11, better showing the lip fastener 230. In particular, lip fastener 230 and lip fastener 240 have inner surfaces 236 and 246, respectively, that are slightly wider at the sheath end of the lip fasteners 230 and 240. In this way, a knife handle having slightly wider portions 238 and 248 can flex the lip fasteners while the knife is inserted into the sheath and can then rest in the slightly wider inner surfaces 236 and 246 while allowing the lip fastener to hold the knife within the sheath by releasing the flex that the knife imparted during insertion into the sheath.

It will further be understood that the configurations and/or approaches described herein are exemplary in nature, and that these specific embodiments or examples are not to be considered in a limiting sense, because numerous variations are possible.

The subject matter of the present disclosure includes all novel and nonobvious combinations and subcombinations of the various processes, systems and configurations, and other features, functions, acts, and/or properties disclosed herein, as well as any and all equivalents thereof.

1. A knife sheath comprising:
a knife opening to receive a knife having a light source, and an internal cavity to sheath a blade of the knife; and
at least one light channel near the knife opening to align with the light source when the knife having a light source is sheathed in the knife opening, the at least one light channel configured to allow light from the light source to pass through the knife sheath while the knife is placed in the knife sheath.
